(19) United States
(12) Patent Application Publication
(10) Pub. No.: US 2004/0155974 A1
(43) Pub. Date: Aug. 12, 2004

(54) Method and apparatus for controlling adaptive menu of digital camera

(75) Inventor: Soon-hac Hong, Seongnam-si (KR)

Correspondence Address: GARDNER CARTON & DOUGLAS LLP, ATTN: PATENT DOCKET DEPT., 191 N. WACKER DRIVE, SUITE 3700, CHICAGO, IL, 60606, US

(73) Assignee: Samsung Techwin Co., Ltd., Changwon-city (KR)

(21) Appl. No.: 10/764,660

(22) Filed: Jan. 26, 2004

(30) Foreign Application Priority Data
Feb. 10, 2003 (KR) 2003-8140

(51) Int. Cl. H04N 5/222

(52) U.S. Cl. 348/333.02

(57) ABSTRACT

In a method of controlling an adaptive menu of a digital camera, at least two menu items are sequentially displayed according to a set display order. An initially active menu item from among the displayed menu items is activated. A user selects a desired menu item. At least one of either the display order of the menu items or the initially active menu item is set according to the number of uses of each of the menu items.

### BACKGROUND OF THE INVENTION

This application claims the priority of Korean Patent Application No. 2003-8140, filed on Feb. 10, 2003, in the Korean Intellectual Property Office, the disclosure of which is incorporated herein in its entirety by reference.

1. Field of the Invention

The present invention relates to a method and apparatus for controlling a menu of a digital camera, and more particularly, to a method and apparatus for controlling an adaptive menu of a digital camera to automatically change a menu display structure according to the number of uses of menu items by a user.

2. Description of the Related Art

When power is supplied to operate a digital camera, a menu is output through a display device such as an LCD panel. The user then operates the menu through the display device using an input device to control the camera functions and take a picture under the desired conditions.

However, since the menu output to the display device of a digital camera is generally set during a design stage, the menu is displayed according to a set display order regardless of the frequency of use of each menu item by the user.

Thus, since the typical digital camera has a user input portion having limited functionality, the user needs to search and set a desired menu item through numerous key operations. In particular, because the menu structure on a typical digital camera is fixed, numerous repetitive key operations are needed to operate a frequently used menu item, which is inconvenient for the user.

Korean Patent Publication No. 2000-020838 discloses an apparatus and method of controlling the output of a menu of an electronic camera. According to a user identification, menu items which are not frequently used are retained beneath a particular top level menu item while menu items which are frequently used are displayed to enhance user's convenience. However, a determination of whether a menu item selected by the user is present is needed, and further operations are needed according to the determination.

### SUMMARY OF THE INVENTION

The present invention is directed to a method and apparatus that satisfies the need for controlling an adaptive menu of a digital camera to automatically change a menu display structure according to the number of uses of menu items by a user.

An aspect of the present invention provides a method of controlling an adaptive menu of a digital camera in which at least two menu items are sequentially displayed according to a set display order, an initially active menu item set among the displayed menu items is activated, and a user selects a desired menu item, wherein either the display order of the menu items, the initially active menu item, or both, is set according to the number of uses of each of the menu items.

The method includes comparing the number of uses of the menu items to be displayed with a set reference number, determining a display order of the menu items to be displayed according to the result of the comparison operation, displaying the menu items according to the display order, determining whether a menu item is selected by the user among the displayed menu items, increasing the number of uses value of a selected menu item, and storing the number of uses value.

The method also includes comparing the number of uses of the menu items to be displayed with a set reference number, determining an initially active menu item among the menu items to be displayed according to the result of the comparison operation, displaying the menu items according to the display order and activating the initially active menu item among the displayed menu items, determining whether a menu item is selected by the user among the displayed menu items, increasing the number of uses value of a selected menu item, and storing the number of uses value.

Another aspect of the present invention provides a digital camera which includes an image photographing portion to photograph an object, an image processing portion to perform predetermined image processing and output the processed digital image data, a recording portion to store the digital image data, a display portion to display and activate the menu items according to the display order and the initially active menu item, an operation portion to select and set a menu item to be set by operating the menu items displayed on the display portion, a storage portion which is non-volatile and stores the number of uses that is the number of selection of the menu items, and a control portion to set at least one of either the display order of the menu items or the initially active menu item according to the number of uses of the menu items.

### BRIEF DESCRIPTION OF THE DRAWINGS

The above and other features and advantages of the present invention will become more apparent by describing in detail preferred embodiments thereof with reference to following description, claims, and attached drawings in which:

FIG. 1 is a perspective view illustrating the front and upper surfaces of a digital camera;

FIG. 2 is a rear view of the digital camera of FIG. 1;

FIG. 3 is a view illustrating the configuration of the light incident side of the digital camera 1 of FIG. 1;

FIG. 4 is a block diagram illustrating the overall structure of the digital camera of FIG. 1;

FIG. 5 is a flow chart for explaining a method of controlling an adaptive menu of a digital camera according to a preferred embodiment of the present invention;

FIG. 6 is a view illustrating a menu at an initial stage to which the method of FIG. 5 is applied;.

FIGS. 7A through 7C are views illustrating menu display structures with corresponding number of uses values according to the method of FIG. 5;

FIG. 8 is a flow chart for explaining a method of controlling an adaptive menu of a digital camera according to another preferred embodiment of the present invention;

FIG. 9 is a view illustrating a menu display structure according to the method of FIG. 8;

FIG. 10 is a view illustrating a menu display structure in a night mode according to the methods of FIGS. 6 and 8;

FIG. 11 is a block diagram illustrating an apparatus for controlling an adaptive menu of a digital camera according to a preferred embodiment of the present invention;

FIG. 12 is a perspective view illustrating a digital camera employing the adaptive menu control apparatus of FIG. 11; and

FIG. 13 is a block diagram illustrating the overall structure of the digital camera of FIG. 12.

### DETAILED DESCRIPTION OF THE INVENTION

FIG. 1 is a perspective view illustrating the front and upper surfaces of a digital camera. Referring to FIG. 1, a microphone MIC, a self-timer lamp 11, a flash 12, a shutter button 13, a mode dial 14, a function selection button 15, a photographing information display portion 16, a viewfinder 17a, a function block button 18, a flash light amount sensor 19, a lens portion 20, and an external interface portion 21 are arranged on the front and upper surfaces of a digital camera 1.

The self-timer lamp 11 flickers during a set time from the time when the shutter button 13 is pressed to the time when a shutter operates, in a self-timer mode. The mode dial 14 is used by a user to select and set one of various modes, for example, a still image photographing mode, a night view photographing mode, a motion picture photographing mode, a play mode, a computer connection mode, and a system setting mode. The function selection button 15 is used to select one of operation modes of the digital camera 1, for example, the still image photographing mode, the night view photographing mode, the motion picture photographing mode, and the play mode. The photographing information display portion 16 displays information on each of the functions related to photographing. The function block button 18 is used for the user to select each function displayed on the photographing information display portion 16.

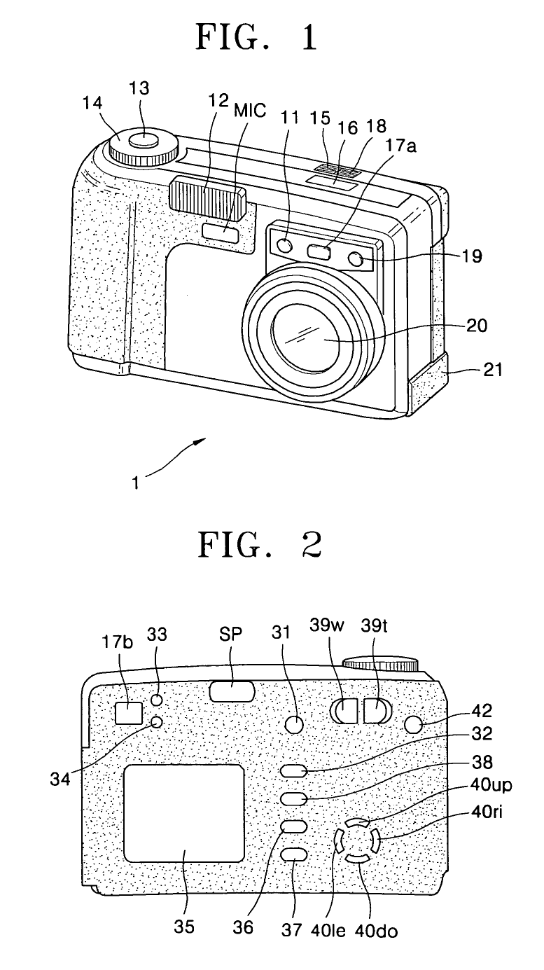

FIG. 2 is a rear view of the digital camera shown in FIG. 1. Referring to FIG. 2, a representative voice button 42, a speaker SP, a power button 31, a monitor button 32, an automatic focus lamp 33, a viewfinder 17b, a flash ready lamp 34, a display panel 35, a confirm/cancel button 36, an enter/play button 37, a menu button 38, a wide-angle zoom button 39w, a telephoto zoom button 39t, an up movement button 40up, a right movement button 40ri, a down movement button 40do, and a left movement button 40le are arranged on the rear surface of a digital camera 1.

When a user presses the representative voice button 42, a representative voice request signal is generated which is a command to generate a new directory and a representative voice file corresponding thereto.

The monitor button 32 is used for a user to control the operation of the display panel 35. For example, when the monitor button 32 is pressed first, an image of an object being photographed and photographing information are displayed on the display panel 35. When the monitor button 32 is pressed second, only the image of an object being photographed is displayed on the display panel 35. When the monitor button 32 is pressed third, power applied to the display panel 35 is cut off. The automatic focus lamp 33 operates when an automatic focusing operation is completed. The flash ready lamp 34 operates when the flash 12 of FIG. 1 is in a ready mode. The confirm/cancel button 36 is used as a confirm button or a cancel button when the user sets each mode. The enter/play mode 37 is used for the user to input data or to set a stop or play function in a play mode. The menu button 38 is used to display a menu of a mode selected using the mode dial 14. The up movement button 40up, the right movement button 40ri, the down movement button 40do, and the left movement button 40le are used when the user sets each mode.

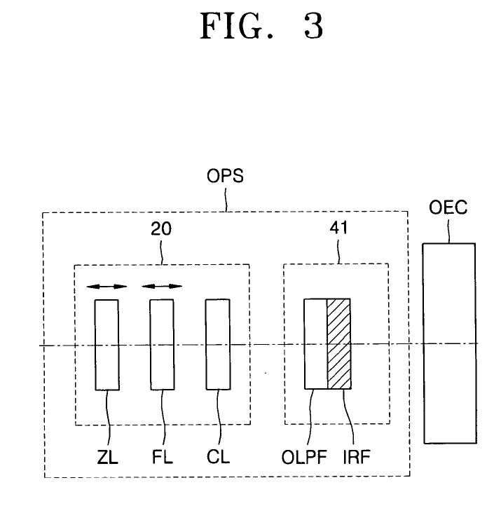

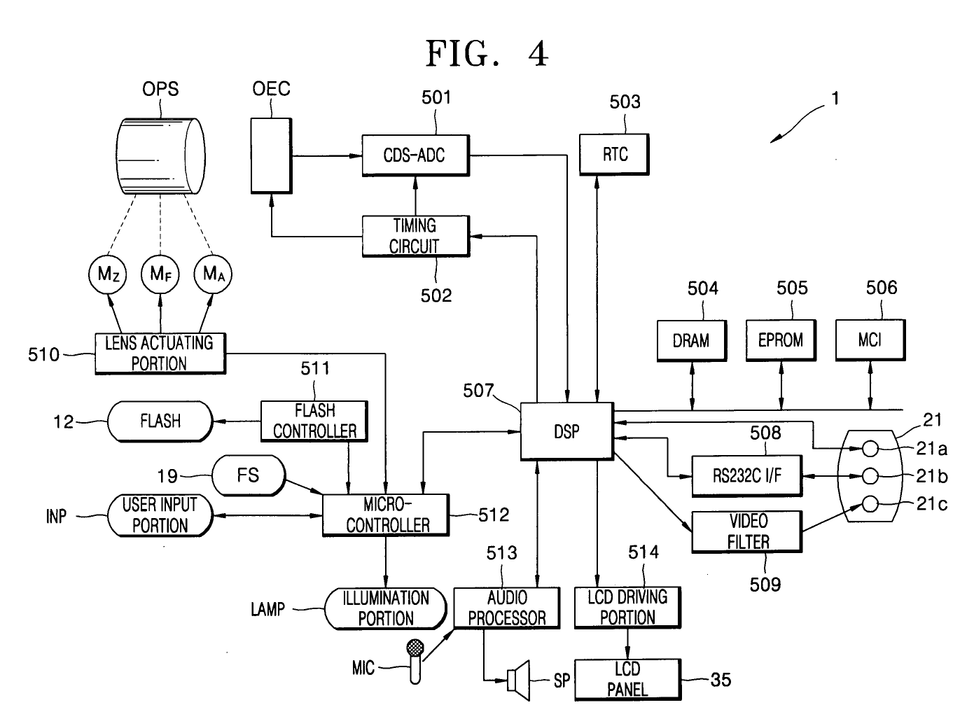

FIG. 3 shows the configuration of the light incident side of the digital camera 1 of FIG. 1. FIG. 4 shows the overall structure of the digital camera 1 of FIG. 1. Referring to FIGS. 3 and 4, the overall structure of the digital camera 1 of FIG. 1 is described below.

An optical system OPS including the lens portion 20 and a filter portion 41 optically processes light from an object subject to photographing. The lens portion 20 of the optical system OPS includes a zoom lens ZL, a focus lens FL, and a compensation lens CL.

When the user presses the wide-angle zoom button 39w of FIG. 2 or the telephoto zoom button 39t of FIG. 2 included in a user input portion INP, a signal corresponding to the pressed button is input to a microcontroller 512. Accordingly, as the microcontroller 512 controls a lens actuating portion 510, a zoom motor M_{z} is actuated to move the zoom lens ZL. That is, when the wide-angle zoom button 39w is pressed, a focal length of the zoom lens ZL decreases so that an angle of view increases. When the telephoto zoom button 39t of FIG. 4 is pressed, the focal length of the zoom lens ZL increases so that an angle of view decreases. According to the above characteristic, the microcontroller 512 obtains an angle of view with respect to the position of the zoom lens ZL from design data of the optical system OPS. Since the position of the focus lens FL is adjusted in a state in which the position of the zoom lens ZL is set, the angle of view is hardly affected by the position of the focus lens FL. The compensation lens CL is not separately actuated since it has a function of compensating for the overall refractive index.

Reference numeral M_{A} denotes a motor for actuating an aperture (not shown). Here, a rotation angle of the aperture actuating motor MA varies according to whether it is a designated exposure mode or not. The designated exposure mode is a mode to set the amount of exposure of the digital camera with respect to an average brightness of a designated detection area indicated on the display panel 35 of the digital camera when part of an area that a user desires in an area being photographed matches the designated detection area.

The filter portion 41 of the optical system OPS includes an optical low pass filter OLPF which removes optical noise of a high frequency and an infrared cut filter IRF which cuts an infrared component of the incident light.

An optoelectric converting portion OEC of a CCD (charge coupled device) or a CMOS (complementary metal-oxide-semiconductor) converts light from the optical system OPS to an electric analog signal. A digital signal processor DSP 507 controls the operation of the optoelectric converting portion OEC and a CDS-ADC (correlation double sampler and analog-to-digital converter) device 501 as an analog-to-digital converting portion by controlling a timing circuit 502. The CDS-ADC device 501 processes the analog signal from the optoelectric converting portion OEC by removing high frequency noise and adjusting amplitude thereof, to convert the processed analog signal to a digital signal. The digital signal processor DSP 507 processes the digital signal from the CDS-ADC device 501 to generate a digital image signal divided into a brightness signal and a chrominance signal.

A illumination portion LAMP operated by the microcontroller 512 includes the self-timer lamp 11 of FIG.1, the automatic focusing lamp 33 of FIG. 2, and the flash ready lamp 34 of FIG. 2. The user input portion INP includes the shutter button 13 of FIG. 1, the mode dial 14 of FIG. 1, the function selection button 15 of FIG. 1, the function block button 18 of the FIG. 1, the monitor button 32 of FIG. 1, the confirm/delete button 36 of FIG. 1, the enter/play button 37 of FIG. 1, the menu button 38 of FIG. 1, the wide-angle zoom button 39w of FIG. 1, the telephoto zoom button 39t of FIG. 1, the up movement button 40up of FIG. 1, the right movement button 40ri of FIG. 1, the down movement button 40do of FIG. 1, and the left movement button 40le of FIG. 1.

The digital image signal from the digital signal processor DSP 507 is temporarily stored in the DRAM (dynamic random access memory) 504. An EEPROM (electrically erasable programmable read only memory) 505 contains algorithm and set data needed for the operation of the digital signal processor DSP 507. A user's memory card is detachably inserted in a memory card interface MCI 506.

The digital image signal from the digital signal processor DSP 507 is input to an LCD driving portion 514 so that an image is displayed on the display panel 35 such as a color LCD panel.

The digital image signal from the digital signal processor 507 can be transmitted in a series communication through a USB (universal serial bus) connection portion 21a, or an RS232C interface 508 and a connection portion 21b. The digital image signal can be transmitted as a video signal through a video filter 509 and a video output portion 21c.

An audio processor 513 outputs a voice signal from the microphone MIC to the digital signal processor DSP 507 or a speaker SP and an audio signal from the digital signal processor 507 to the speaker SP. The flash 12 is driven by the microcontroller 512 and a flash controller 511 according to the signal from the flash light amount sensor 19.

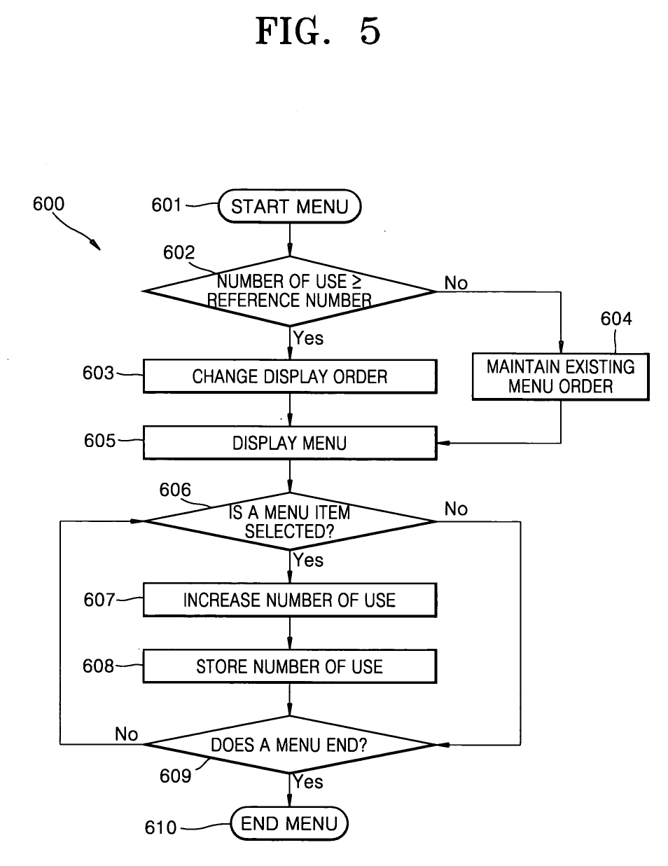

Referring to FIGS. 5 and 6, in a method 600 of controlling an adaptive menu of a digital camera in which at least two menu items are sequentially displayed according to a set display order, an initially active menu item among the displayed menu items is activated, and a user selects a desired menu item, and the display order of the menu items is set according to the number of uses of the menu items.

For this purpose, the method 600 preferably includes a comparison step 602, a display order determination step 603 and 604, a display step 605, a menu item selection determination step 606, an increment step 607, and a storage step 608.

In the comparison step 602, the number of uses of each of the menu items to be displayed is compared with a set reference number. In the display order determination step 603 and 604, a menu item is determined to be initially active from among the menu items to be displayed, according to the result of the comparison in the step 602. In the display step 605, menu items are displayed according to the display order and the initially active menu item is activated. In the menu item selection determination step 606, it is determined whether a user selects a menu item among the displayed menu items. In the increment step 607, if a menu item is selected in the determination menu 606, the number of uses value of the selected menu item is increased. In the storage menu 608, the number of uses value is set and stored.

The steps 602 through 608 are initiated from a menu start step 601 which is executed by a user. Whether to end a menu is determined in a menu ending determination step 609 after the storage step 608. The menu is ended by the user in the menu ending step 610.

In the comparison step 602, when the number of uses of the menu items to be displayed is compared with the set reference number, the number of uses can be a value stored in a non-volatile storage portion in the storage step 608. However, when the menu has not been used before, a default value is used which is set when the method of controlling a menu of a digital camera is designed. Also, although the reference number uses a value set when the method is designed, it can be set by the user as necessary.

In the display order determination step 603 and 604, the display order of the menu is determined according to the result of comparison in step 602. The display order determination step 603 and 604 may include a display order change step 603 and an existing menu order maintenance step 604.

When it is determined in the comparison step 602 that a menu item's number of uses value is greater than the reference number, the display order is changed in the display order change step 603. When no menu item's number of uses value is greater than the reference number, the set display order is not changed in the existing menu order maintenance step 604, and the menu items are displayed in an order used for displaying the previous menu.

In the display order change step 603, when a menu item's number of uses value is greater than the reference number, the display order of the menu items are changed according to the order of the number of uses. The display order of the menu items are preferably adjusted such that the menu items whose number of uses are greater than the reference number can be displayed first according to the order of the number of uses and the menu items whose number of uses are less than the reference number are displayed next to the menu items whose number of uses are greater than the reference number.

In the display step 605, the menu items are displayed according to the display order. The menu items are displayed on a display portion such as a LCD panel according to the display order determined in the display order determination step 603 and 604. The first menu item of the displayed menu items is preferably activated so that the active menu item can be set. The menu items can have the same order and structure as shown in FIG. 6. The user can select a desired value at the right with respect to each of the menu items at the left. The hatched menu item indicates an active menu item which can be set by the user, which is the same in the following descriptions.

In the menu item selection determination step 606, which menu item is selected among the displayed menu items is determined and, when no menu item is selected, the menu ending determination step 609 is performed without a change in the number of uses. When a menu item is selected, the increment step 607, the storage step 608, and the menu ending determination step 609 are performed.

In the increment step 607, when a menu item is selected in the menu item selection determination step 606, the number of uses value of the selected menu item is increased so that the menu can be displayed in the present menu control method.

In the storage step 608, the number of uses value increased in the increment step 607 is stored in a predetermined storage means. The stored number of uses value is used when the menu is displayed next time. The number of uses value is preferably stored in a non-volatile storage means such as an EEPROM (electrically erasable programmable read only memory). Thus, when the camera is re-operated, the menu can be displayed according to the previously set number of uses.

The method 600 of controlling an adaptive menu of a digital camera includes the menu ending determination step 609 after the storage step 608, in which, when the menu is ended, the menu is terminated (Step 610) and, when the menu is not ended, the menu item selection determination step 606 is performed. The digital camera waits for a menu ending signal or menu selection signal and, when the signal is received, an operation according to the signal may be performed.

After the number of uses value is stored in the storage step 608, the present menu display structure may be immediately changed. For this purpose, after the storage step 608 is performed, the comparison step 602, the display order determination step 603 and 604, and the display step 605 are performed.

A user identification step (not shown) to identify a user is further provided prior to the menu start step 601. Thus, the menu display order preferably varies according to users. A user identification method and apparatus is disclosed in Korean Patent Application No. 2002-057333 filed by the present applicant, of which content is assumed to be included in the present specification and thus a detailed description thereof is omitted.

According to a preferred embodiment of the present invention, when using the menu next time, the user can easily access and set a frequently used menu item with less key operations by the newly changed menu order.

In the method of controlling an adaptive menu of a digital camera according to a preferred embodiment of the present invention, the menu display structure is automatically changed according to the number of uses. Thus, when using the menu, the user can set a desired menu item with less key operations.

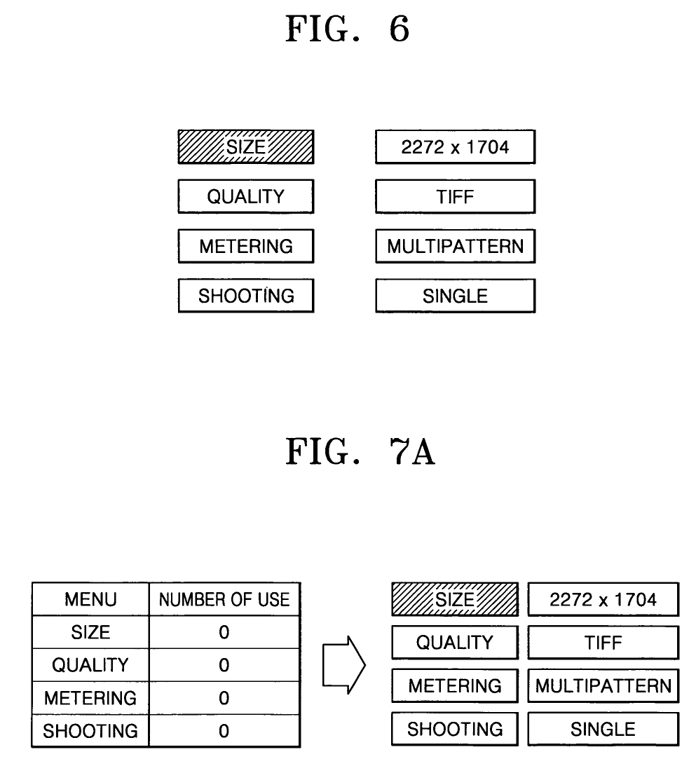

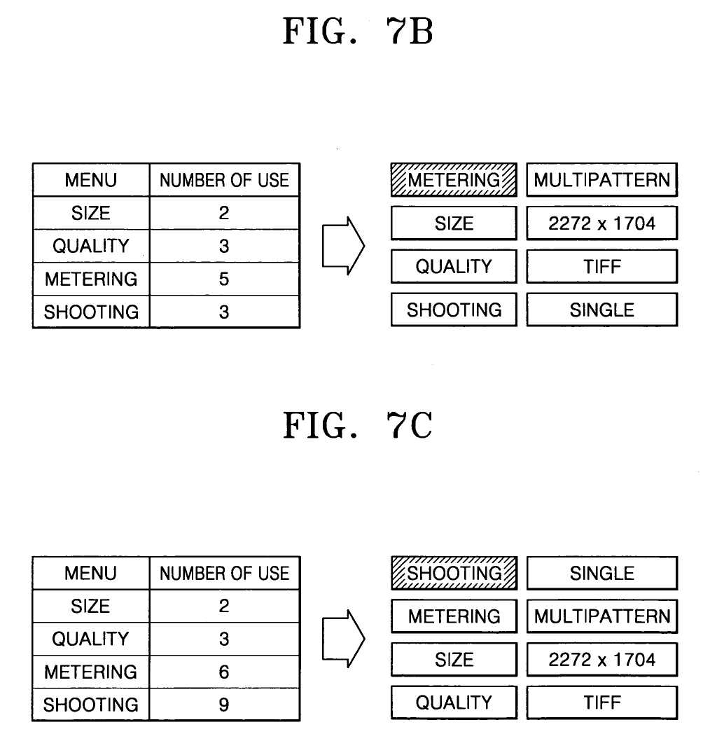

FIGS. 7A through 7C show examples of the menu display structure according to the number of uses in the method of controlling an adaptive menu of a digital camera of FIG. 6. Referring to FIGS. 7A through 7C, menus are displayed in different structures according to the number of uses of the respective menu items in the method of controlling an adaptive menu of a digital camera according to a preferred embodiment of the present invention. In the present preferred embodiment, the reference number is 5. A menu item positioned on the top of the displayed menu items is activated to allow initial selection by the user.

FIG. 7A shows a case in which the number of uses for all menu items is 0. FIG. 7B shows a case in which only one menu item, “METERING,” is greater than the reference number, and “METERING” is moved to the top while the other menu items remain in the same order.

In FIG. 7C, the number of uses of menu items “METERING” and “SHOOTING” are 6 and 9, respectively, which are greater than the reference number “5”. The menu item “SHOOTING,” with a relatively greater number of uses, is displayed first and the menu item “METERING” is displayed next. The other menu items “SIZE” and “QUALITY” are displayed adjacent to the menu items “METERING” and “SHOOTING”, in the previous display order regardless of the number of uses.

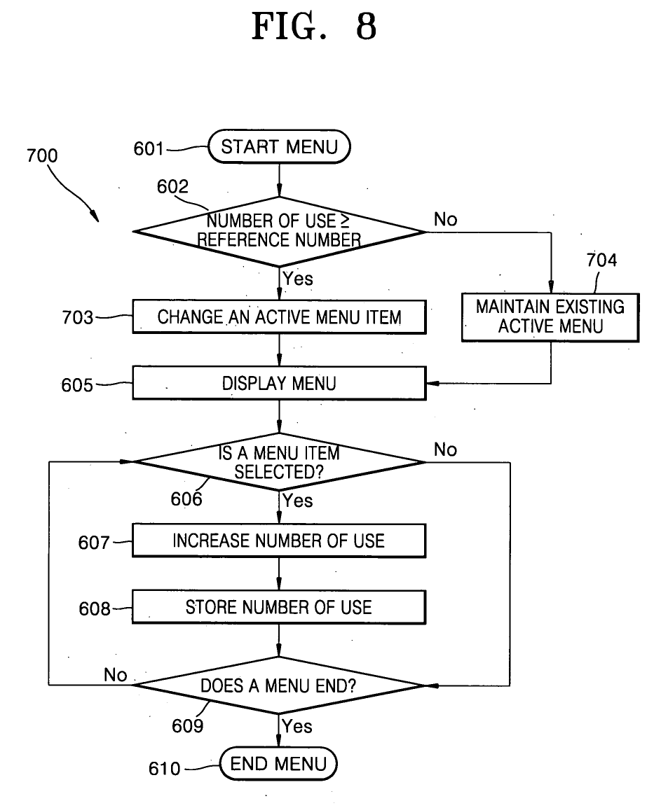

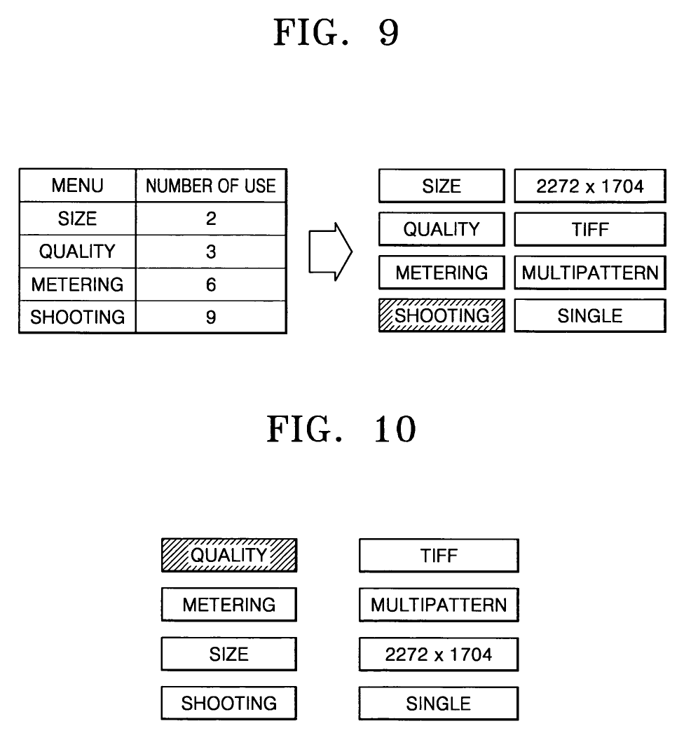

FIG. 8 is a flow chart for explaining a method of controlling an adaptive menu of a digital camera according to another preferred embodiment of the present invention. FIG. 9 is a view illustrating a menu display structure according to the method of FIG. 8 In FIGS. 8 and 9, since the steps in the method shown in FIG. 8 and 9 having the same step numbers as those in the method 600 shown in FIG. 5 are the same steps having the same functions, detailed descriptions thereof will be omitted.

Referring to FIGS. 8 and 9, in a method 700 of controlling an adaptive menu of a digital camera in which at least two menu items are sequentially displayed according to a set display order, an initially active menu item among the displayed menu items is activated, and a user selects a desired menu item, the initially active menu item is set according to the number of uses of the menu items in a method 700 of controlling an adaptive menu of a digital camera.

For this purpose, the method 700 preferably includes the comparison step 602, an display order determination step 703 and 704, the display step 605, the menu item selection determination step 606, the increment step 607, and the storage step 608.

In the comparison step 602, the number of uses of each of the menu items to be displayed is compared with a set reference number. In the display order determination step 703 and 704, an initially active menu item is determined among the menu items to be displayed according to the result of the comparison in the step 602. In the display step 605, menu items are displayed according to the display order and the initially active menu item determined among the displayed menu items is activated. In the menu item selection determination step 606, it is determined whether a user selects a menu item among the displayed menu items. In the increment step 607, if a menu item is selected in the determination menu 606, the number of uses value of the selected menu item is increased. In the storage menu 608, the number of uses value is stored.

The steps 602 through 608 are initiated from the menu start step 601 which is executed by a user. Whether to end a menu is determined in the menu ending determination step 609 after the storage step 608. The menu is ended by the user in the menu ending step 610.

In the display order determination step 703 and 704, an initially active menu item is determined among the menu items to be displayed according to the result of comparison in the comparison step 602. The display order determination step 703 and 704 may include an active menu display change step 703 and an existing active menu maintenance step 704.

In the active menu change step 703, if menu items having the number of uses over the reference number exit, the initially active menu item is changed according to the order of the number of uses. A menu item having the largest number of uses is set as an initially active menu item and is activated when the menu is displayed.

In the present preferred embodiment, the display structure of the menu items is not changed and the menu items are displayed according to the existing display order. The menu item activated according to the number of uses is displayed by being changed. In particular, when the number of uses is less than the reference number, the existing initially active menu item is maintained. The initially active menu item is changed only when the number of uses is equal to or greater than the reference number.

Referring to FIG. 9, the numbers of the menu items “METERING” and “SHOOTING” are 6 and 9, respectively, which are greater than the reference number “5”. Thus, the display structure of the menu items is not changed and the menu items are displayed according to the existing display order. The menu item “SHOOTING” has the largest number of uses among the menu items and is activated so that the user can set the menu.

FIG. 10 shows the menu display structure in a night mode in the method of controlling an adaptive menu of a digital camera of FIGS. 6 and 8. Referring to FIG. 10, the menu items can be displayed and activated in a different structure by separately managing the same menu item according to the operation mode. That is, at least one of: the display order of the menu items, and the initially active menu item, is preferably set differently according to the operation mode of the digital camera.

As shown in FIGS. 1 and 2, in a digital camera, a variety of modes can be selected by the mode dial 14 of FIG. 1 and the function selection button 15 of FIG. 1. The operation modes selected by using the mode dial 14 and the function selection button 15, include a still image mode, a motion picture mode, a night mode, a daylight mode, a reproduction mode, a computer connection mode, and a system setting mode.

The frequently selected menu item can be different according to each of the operation modes. For this purpose, a default display order can be set differently according to the operation mode in the design process of the method of controlling an adaptive menu of a digital camera according to the present invention. Also, the menu can be displayed by reflecting the number of selections of the menu items in a corresponding operation mode.

FIG. 10 shows an example of the night mode. Since the menu item “QUALITY” is frequently selected at night, the menu item “QUALITY” is initially activated and displayed at the top position of the displayed menu items.

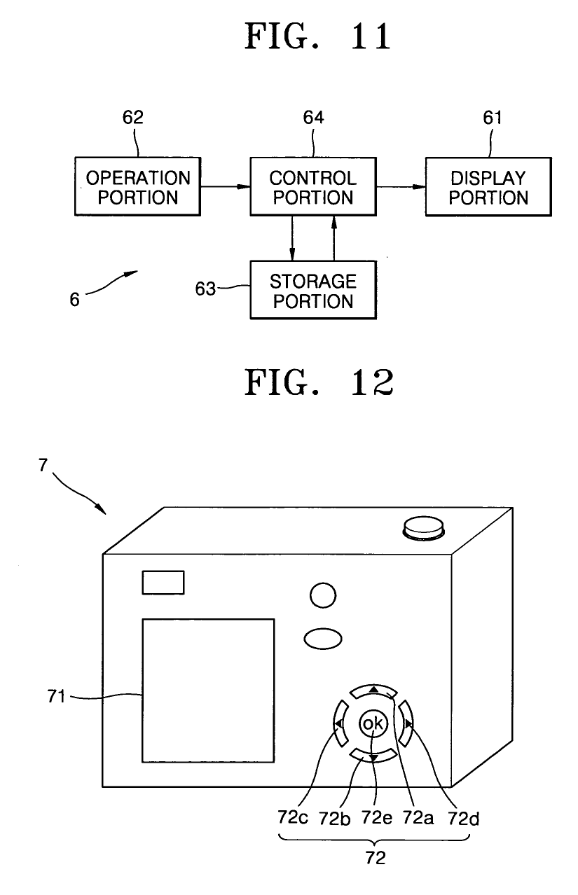

FIG. 11 is a block diagram illustrating an apparatus for controlling an adaptive menu of a digital camera according to a preferred embodiment of the present invention. Referring to FIG. 11, in a digital camera which sequentially displays at least two menu items according to a set display order, activates an initially active menu item set among the displayed menu items, and enables a user to select a desired menu item, an apparatus 6 for controlling an adaptive menu according to a preferred embodiment of the present invention includes a display portion 61, an operation portion 62, a storage portion 63, and a control portion 64.

The display portion 61 displays and activates the menu items according to the display order and the initially active menu item. The operation portion 62 selects a menu item by operating the menu items displayed in the display portion 61. The storage portion 63, a non-volatile storage means, stores the number of uses value for each menu item. The control portion 64 sets at least one of: the display order of the menu items, and the initially active menu item, according to the number of uses of the menu items.

The operation portion 62 preferably includes a directional movement button to move a cursor of the menu items displayed on the display portion 61 to the upper, lower, left, and right sides, and a selection button to select the menu item by using the directional movement button.

The control portion 64 preferably changes at least one of: the display order of the menu items, and the initially active menu item, according to the order of the number of uses; only when a menu item with number of uses greater than the reference number exist.

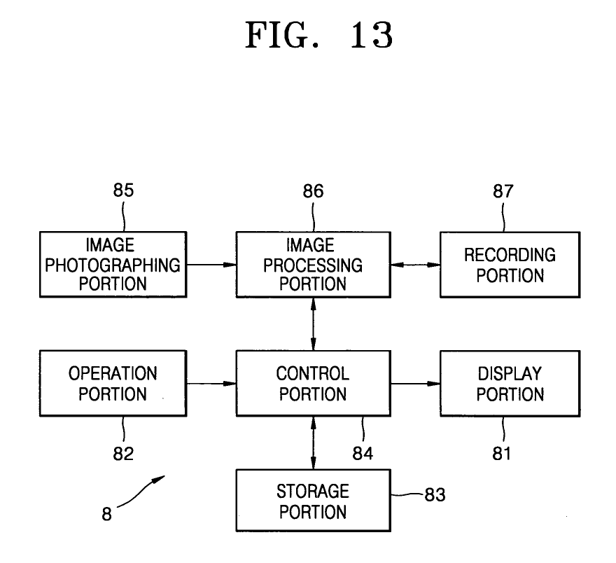

FIG. 12 is a perspective view illustrating a digital camera employing the adaptive menu control apparatus of FIG. 11. FIG. 13 is a block diagram illustrating the overall structure of the digital camera of FIG. 12.

Referring to FIGS. 12 and 13, a digital camera 7 (or 8) having an image photographing portion 85 to photograph an object, an image processing portion 86 to perform predetermined image processing with respect to the photographed image from the image photographing portion 85 and output the processed digital image data, and a recording portion 87 to store the digital image data, in which at least two menu items are sequentially displayed in the set display order, a set initially active menu item among the displayed menu items is activated, and a uses can select and set a desired menu item, includes a display portion 71 and 81, an operation portion 72 and 82, a storage portion 83, and a control portion 84.

The display portion 71 and 81 displays and activates the menu items according to the display order and the initially active menu item. The operation portion 72 and 82 operates the menu items displayed on the display portion to select a menu item. The storage portion 83, a non-volatile storage means, stores the number of uses value for the menu items. The control portion 84 sets at least one of: the display order of the menu items, and the initially active menu item, according to the number of uses of the menu items.

An LCD panel 71 is preferably used as the display portion 81. Directional movement buttons including an upper movement button 72a, a lower movement button 72b, a left movement button 72c, and a right movement button 72d to move selection of the menu items displayed on the display portion 81 to the upper, lower, left, and right sides, respectively, and a selection button 72e are preferably provided as the operation portion 82.

To select and set the menu items displayed on the LCD panel 71 as shown in FIG. 6, a menu item to be set is selected by moving a cursor of the menu item to the upper, lower, left, and right sides using the directional movement buttons 72a, 72n, 72c, and 72d. Thus, the corresponding menu is activated and the menu item activated by the selection button 72e is selected.

The digital camera according to the present preferred embodiment includes the apparatus for controlling an adaptive menu of a digital camera of FIG. 11. A detailed description about the same constituent elements as those shown in FIG. 11 is omitted.

As described above, in the method and apparatus for controlling an adaptive menu of a digital camera according to the present invention, the menu display structure is automatically changed according to the number of uses so that a desired setting is obtained with less key operations.

While this invention has been particularly shown and described with reference to preferred embodiments thereof, it will be understood by those skilled in the art that various changes in form and details may be made therein without departing from the spirit and scope of the invention as defined by the appended claims.

What is claimed is:

1. A method of controlling a menu of a digital camera, the method comprising:
comparing a number of uses value for each menu item to a reference number;
determining a display order of the menu items according to the result of the comparison;
displaying the menu items according to the display order;

2. The method of claim 1, further comprising:
determining whether a menu item is selected by the user among the displayed menu items;
increasing the number of uses value for the selected menu item; and
storing the number of uses value.

3. The method as claimed in claim 1, wherein during the display order determination step, the set display order is not changed when a menu item having the number of uses which is greater than the reference number does not exist.

4. The method as claimed in claim 1, wherein during the display order determination step, when a menu item has a number of uses value greater than the reference number, the display order of the menu items is changed according to the order of the number of uses.

5. The method as claimed in claim 4, wherein during the display order determination step, the menu items with number of uses greater than the reference number are displayed first according to the order of the number of uses and the menu items with number of uses less than the reference number are displayed without a change in the display order adjacent to the menu items with number of uses greater than the reference number.

6. The method as claimed in claim 1, wherein the reference number can be set by the user.

7. The method as claimed in claim 1, wherein the reference number is preset to a default value.

8. The method as claimed in claim 1, wherein the reference number and menu order may be different for different operating modes.

9. The method as claimed in claim 1, wherein the first displayed menu item is initially active during the display operation.

10. The method as claimed in claim 1, wherein the stored number of uses values may be altered by the user.

11. The method as claimed in claim 2, wherein the menu order is immediately updated after a menu item is selected.

12. A method of controlling a menu of a digital camera, the method comprising:
comparing the number of uses of the menu items to be displayed with a reference number;
determining whether a menu item will be initially active from among the menu items to be displayed according to the result of the comparison step;
displaying the menu items and activating the initial active menu item from among the displayed menu items;

13. The method of claim 12, further comprising:
determining whether a menu item is selected by the user among the displayed menu items;
increasing the number of uses value of a selected menu item when the menu item is selected; and
storing the number of uses value.

14. The method of claim 12, wherein the step of determining whether a menu item will be initially active further comprises:
when there is no number of uses value of a menu item greater than the reference number, not changing which menu item is initially active.

15. The method of claim 12, wherein the step of determining whether a menu item will be initially active further comprises:
when at least one number of uses value of a menu item is greater than the reference number, setting the menu item having the largest number of uses value as the initially active menu item.

16. The method of claim 12, wherein the reference number can be set by the user.

17. The method of claim 12, wherein, the reference number is preset to a default value.

18. The method of claim 12, wherein the reference number is different for different operating modes.

19. The method of claim 12, wherein the stored number of uses values may be altered by the user.

20. A digital camera capable of controlling an adaptive menu, the camera comprising:
an image photographing portion to photograph an object;
an image processing portion to perform predetermined image processing and output the processed digital image data;
a recording portion to store the digital image data;
a display portion to display the menu items in a display order and activate the menu items with one menu item initially active;
an operation portion to select a menu item displayed on the display portion;
a storage portion which is non-volatile and stores number of uses values of the menu items; and
a control portion to set at least one of either the display order of the menu items or the initially active menu item, according to the number of uses of the menu items.

21. The apparatus as claimed in claim 20, wherein the operation portion comprises directional movement buttons to allow selection of the menu items displayed on the display portion to the upper, lower, left, and right sides of the initially active menu item and a selection button to select the menu item.

22. The apparatus as claimed in claim 20, wherein the control portion changes the display order of the menu items according to the size order of the number of uses values.

23. The apparatus as claimed in claim 22, wherein the control portion changes the display order of the menu items according to the size order of the number of uses values only when a menu item's number of uses value is greater than a reference number.

24. The apparatus as claimed in claim 20, wherein the control portion determines the initially active menu item to be the menu item with the largest number of uses value.

25. The apparatus as claimed in claim 20, wherein the control portion determines the initially active menu item according to the size of the number of uses value only when a menu item's number of uses value is greater than a reference number.
